(19) United States
(12) Patent Application Publication
(10) Pub. No.: US 2021/0254405 A1
(43) Pub. Date: Aug. 19, 2021

(54) Ladder Caddy

(71) Applicant: Hugh Pennell, Conyers, GA (US)

(72) Inventor: Hugh Pennell, Conyers, GA (US)

(21) Appl. No.: 17/178,650

(22) Filed: Feb. 18, 2021

Related U.S. Application Data
(60) Provisional application No. 62/977,845, filed on Feb. 18, 2020.

(51) Int. Cl. E06C 7/14

(52) U.S. Cl. CPC E06C 7/14

(57) ABSTRACT

A ladder caddy is provided. The device includes a container having a base with a perimeter sidewall defining an interior volume with an open upper end. In some embodiments, the base is circular, whereas, in alternate embodiments, the base is rectangular. A threaded rod is affixed to the container through a center of the base. A plurality of movable walls is removably securable within the interior volume, thereby subdividing the interior volume into a plurality of compartments. A handle having an aperture therethrough is removably securable to the threaded rod via the aperture.

### CROSS REFERENCE TO RELATED APPLICATIONS

This application claims the benefit of U.S. Provisional Application No. 62/977,845 filed on Feb. 18, 2020. The above identified patent application is herein incorporated by reference in its entirety to provide continuity of disclosure.

### BACKGROUND OF THE INVENTION

The present invention relates to ladder caddies. More particularly, the present invention pertains to a ladder caddy having a plurality of movable walls allowing the user to reconfigure the compartments defined within the container.

Many individuals regularly utilize ladders to perform various tasks. Often, a user must bring several tools, fasteners, or other accessories when climbing up the ladder to minimize trips required to retrieve a necessary item. However, typical ladders provide minimal storage areas for accumulated items to be placed when not actively in use. Often, traditional ladders provide an upper platform on or adjacent to the uppermost rungs of the ladder, however fasteners or other items may roll off of the platform or be easily dislodged therefrom during use. Furthermore, climbing a ladder while carrying several discrete small items can be particularly difficult or unsafe, as a user should maintain at least three points of contact on the ladder while climbing. Therefore, a device that can store several discrete items for use on a ladder that can be easily carried in a single hand and can be secured to the ladder to ensure the items are not dislodged therefrom is desired.

In light of the devices disclosed in the known art, it is submitted that the present invention substantially diverges in design elements from the known art and consequently it is clear that there is a need in the art for an improvement to existing ladder caddies. In this regard, the instant invention substantially fulfills these needs.

### SUMMARY OF THE INVENTION

In view of the foregoing disadvantages inherent in the known types of ladder caddies now present in the known art, the present invention provides a ladder caddy wherein the same can be utilized for providing convenience for the user when keeping several tools, fasteners, and accessories organized and contained upon a ladder platform.

The present system comprises a container having a base with a perimeter sidewall defining an interior volume with an open upper end. In some embodiments, the base comprises a circular cross-section, whereas, in alternate embodiments, the base comprises a rectangular cross-section. A threaded rod is affixed through a center of the base. A plurality of movable walls is removably securable within the interior volume subdividing the interior volume into a plurality of compartments. A handle having an aperture therethrough is removably securable to the threaded rod via the aperture.

In some embodiments, the plurality of movable walls comprises a length equivalent to a radius of the base, such that the plurality of movable walls secures within the container via frictional engagement, between the threaded rod and the perimeter sidewall. In other embodiments, the plurality of movable walls comprises a length equivalent to at least half of the base, such that the plurality of movable walls secures within the container via frictional engagement. In another embodiment, at least one slot is disposed within the base, wherein the slot is configured to receive a lower edge of a movable wall of the plurality of movable walls therein. In yet another embodiment, the aperture comprises complementary threading therein, configured to removably secure to the threaded rod. In some embodiments, the aperture is disposed in a center of the handle. In another embodiment, a width of the handle tapers from a center thereof towards opposing ends of the handle. In other embodiments, the plurality of compartments defined by the plurality of movable walls comprise a circular sector of the base, wherein a circular sector is defined as the wedge of the base between two radii and an arc length of the base. In yet another embodiment, a lower end of the threaded rod extends through a lower side of the base, wherein the handle is configured to removably secure to the lower end. In some embodiments, the plurality of movable walls comprises a variety of lengths. In another embodiment, the plurality of compartments defined by the plurality of movable walls comprise a variety of areas.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows an exploded view of an embodiment of the ladder caddy.

FIG. 1B shows an exploded view of an alternate embodiment of the ladder caddy.

FIG. 2 shows a perspective view of the handle of an embodiment of the ladder caddy.

FIG. 3 shows a side view of an embodiment of the ladder caddy.

FIG. 4 shows a perspective view of an embodiment of the ladder caddy in use.

### DETAILED DESCRIPTION OF THE INVENTION

Reference is made herein to the attached drawings. Like reference numerals are used throughout the drawings to depict like or similar elements of the ladder caddy. The figures are intended for representative purposes only and should not be considered to be limiting in any respect.

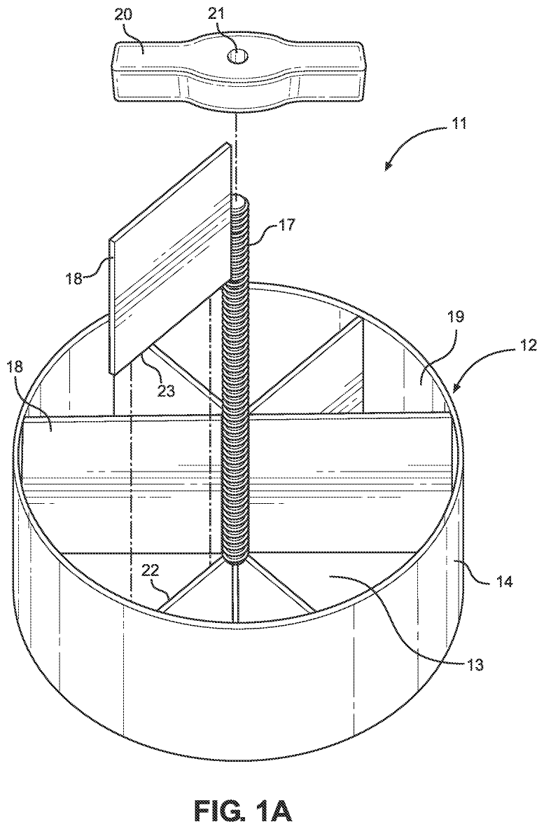

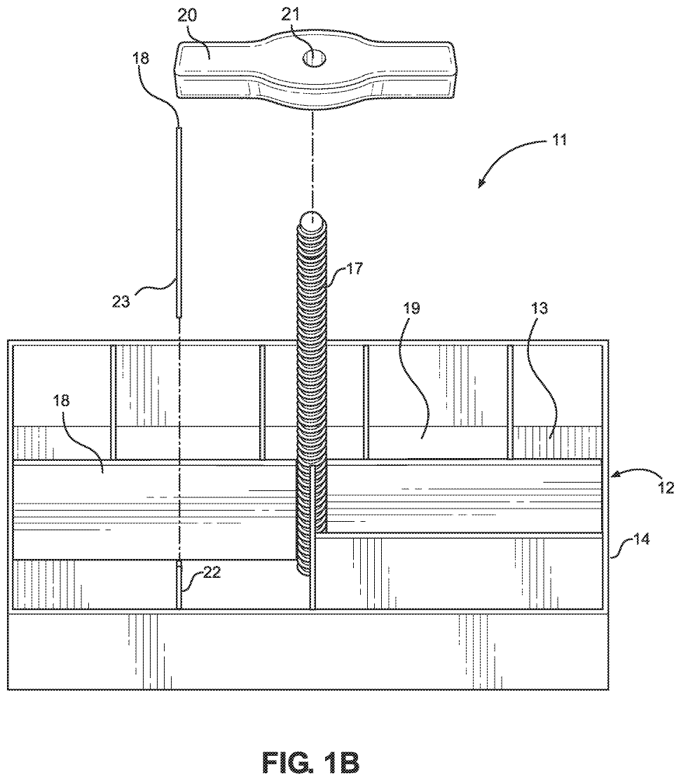

Referring now to FIGS. 1A and 1B, there are shown exploded views of various embodiments of the ladder caddy. The ladder caddy 11 comprises a container 12 having a base 13 and a perimeter sidewall 14, thereby defining an interior volume. The container 12 further comprises an open upper end providing access to the interior volume. A threaded rod 17 extends through a center of the base 13, wherein the threaded rod 17 provides a securement point for a handle 20 via an aperture 21 therethrough. The handle 20 can be selectively secured to either an upper end of the threaded rod 17 or a lower end of the threaded rod 17, such that the user can reconfigure the ladder caddy 11 for toting purposes or for securement to a ladder, respectively. A plurality of movable walls 18 are securable within the container 12 to define a plurality of compartments 19 within the interior volume. In the illustrated embodiment of FIG. 1A, the base 13 comprises a circular cross-section, whereas in the shown embodiment of FIG. 18, the base 13 comprises a rectangular cross-section. Each base 13 provides various benefits that may be desirable to the user. For example, the circular base 13 of FIG. 1A can utilize movable walls 18 having a uniform length, whereas the rectangular base 13 of FIG. 1B provides compartments 19 that may be more readily reconfigured for various sizes of items to be stored therein. In operation of the embodiment, of FIG. 1A, the movable walls 18 define compartments 19 comprising a circular sector defined between two radii of the circular base 13 and an associated arc length of the perimeter sidewall 14.

In some embodiments, the plurality of movable walls 18 are removably securable within the container 12 via frictional engagement between the perimeter sidewall 14, the threaded rod 17, or additional movable walls 18. In this manner, the user can selectively adjust the size of the plurality of compartments 19 to suit the user's need rather than relying on predefined compartment dimensions. In the illustrated embodiment, the base 13 further comprises at least one slot 22 therein, wherein the slot 22 is dimensioned to receive a lower edge 23 of the movable walls 18 therein. In this manner, the movable walls 18 are further secured within the container 12 to prevent shifting of the movable walls 18 during use. In such embodiments, the slots 22 can be distributed across the base 13 to create a variety of configurations for the plurality of compartments 19, thereby allowing the user to selectively determine the size and shape of the plurality of compartments 19 as desired. In the shown embodiment of FIG. 1B, the plurality of movable walls 13 are contemplated to include a variety of lengths to define compartments of various areas. In this manner, the plurality of compartments 19 can be configured to secure objects of elongated dimensions. In the illustrated embodiment of FIG. 1A, the plurality of movable walls 18 are contemplated to comprise a length equivalent to a radius of the base 13. In some embodiments, one or more walls are permanently affixed within the container 12 to increase structural stability of the ladder caddy 11. In the shown embodiments, the plurality of movable walls 18 comprise a substantially rectangular form factor, however, it is contemplated that the plurality of movable walls 18 are dimensioned to correspond to the format of the container 12. For example, in embodiments having an outwardly flaring perimeter sidewall 14, a lateral edge of the plurality of movable walls 18 may be angled to correspond to the perimeter sidewall 14. In another embodiment, a height of the plurality of movable walls 18 are contemplated to comprise a height equivalent to that of the perimeter sidewall 14. In this manner, a volume defined within each of the plurality of compartments 19 is maximized.

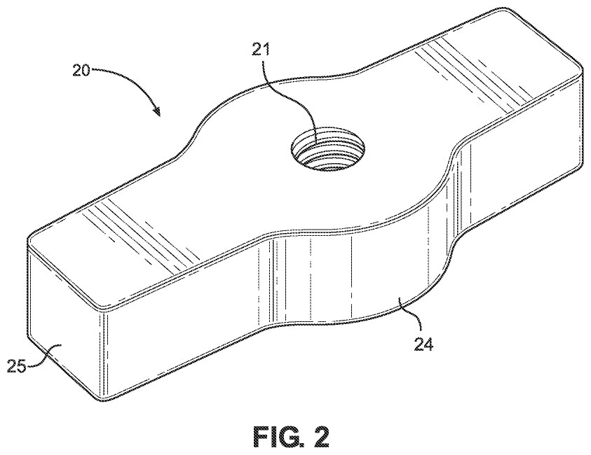

Referring now to FIG. 2, there is shown a perspective view of the handle of an embodiment of the ladder caddy. The handle 20 includes an aperture 21 disposed through a center 24 of the handle 20, wherein the aperture 21 comprises complementary threading therethrough configured to selectively engage the threaded rod. The handle 20 can be removably secured to either end of the threaded rod to selectively serve as a gripping surface or a securement toggle to affix the container to a ladder platform or other surface. In the illustrated embodiment, a width of the handle 20 tapers inwardly relative to a longitudinal axis of the handle 20 from a center 24 to each opposing end 25 of the handle 20. In this manner, the handle 20 forms an ergonomic gripping surface for increasing user comfort during use. In some embodiments, the handle 20 further comprises a high friction material coating thereon, such as rubber to increase frictional engagement with the user's hand or the underside of a ladder platform. In some further embodiments, the handle 20 further comprises a textured outer surface to increase the surface area in contact with the hand or ladder platform to further increase frictional engagement therewith.

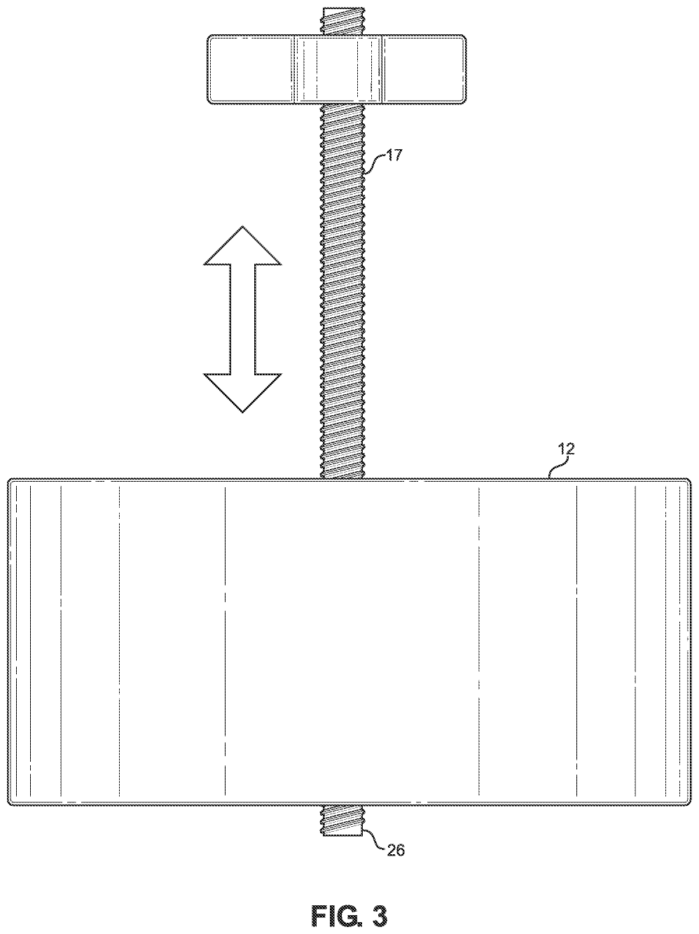

Referring now to FIG. 3, there is shown a side view of an embodiment of the ladder caddy. In the illustrated embodiment, the threaded rod 17 extends entirely through the base of the container 12, such that a lower end 25 of the threaded rod 17 is exposed below the container 12. in some embodiments, the opening through the base is threaded allowing the user to selectively raise or lower the container 12 along a length of the threaded rod 17. In this manner, the user can reposition the container 12 along the threaded rod 17 to allow the handle to be secured thereto for carrying purposes or securement purposes. For example, the user may raise the container 12 along the threaded rod 17 such that the lower end 26 comprises a sufficient length to extend through a ladder platform and receive the handle thereon, such that the container 12 is secured thereto. Alternatively, when not. secured to the ladder platform, the user may wish to lower the container 12 along the threaded rod 17 to secure the handle to the upper end of the threaded rod 17 to allow the user to easily carry the device.

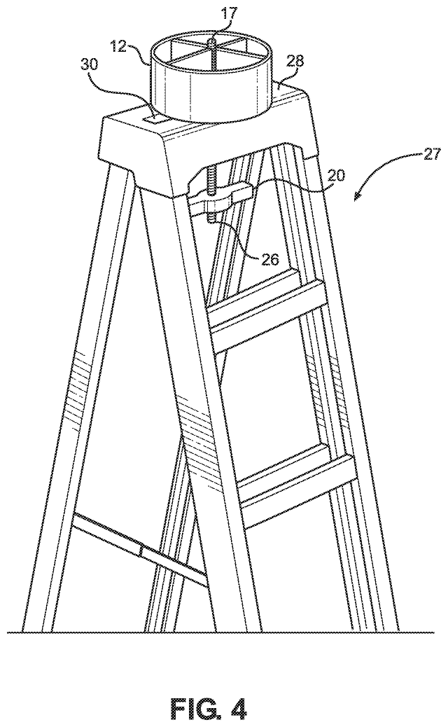

Referring now to FIG. 4, there is shown a perspective view of an embodiment of the ladder caddy in use. The container 12 is removably securable to a ladder 27 to allow the user to secure a variety of tools or other items to the ladder for easy retrieval during use. In this manner, the user can avoid repetitive trips up and down the ladder 27 to retrieve additional items. In the shown embodiment, the ladder 27 comprises an upper platform 28 having an opening 30 therein. It is understood that alternate ladder 27 constructions commonly include similar openings 30 for securement of the threaded rod 17 therethrough, whether explicitly disposed within a ladder platform, or formed between adjacent planks forming the platform 28. In one use, the user can affix the handle 20 to an upper end of the threaded rod 17 to act as a gripping surface. Upon adjusting the configuration of the plurality of compartments within the container 12 via manipulation of the plurality of movable walls, the user can separately store various items, such as screws, nails, bolts, nuts, washers, tools, and the like in separate compartments. The user can then grip the handle 20 and climb the ladder 27 to easily transport each of the items necessary for a task at the top of the ladder 27. Once there, the user can place the container 12 on the ladder platform 28 and adjust the height of the container 12 along the threaded rod 17 such that the lower end 26 can be inserted through the opening 30 disposed through the platform 28. Once properly positioned, the user can remove the handle 20 from the upper end of the threaded rod 17 and secure it to the lower end 26 of the threaded rod 17. In this manner, the container 12 can be secured to ladder 27.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent, relationships to those illustrated in the drawings and described in the specification are intended to be encompassed by the present, invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ladder caddy, comprising:
a container having a circular base with a perimeter sidewall defining an interior volume with an open upper end;
a threaded rod affixed through a center of the base;
a plurality of movable walls removably securable within the interior volume subdividing the interior volume into a plurality of compartments;
a handle having an aperture therethrough, the handle removably securable to the threaded rod via the aperture.

2. The ladder caddy of claim 1, wherein the plurality of movable walls comprises a length equivalent to a radius of the base, such that the plurality of movable wails secures within the container via frictional engagement between the threaded rod and the perimeter sidewall.

3. The ladder caddy of claim 1, further comprising at least one slot disposed within the base, wherein the slot is configured to receive a lower edge of a movable wall of the plurality of movable walls therein.

4. The ladder caddy of claim 1, wherein the aperture comprises complementary threading therein configured to removably secure to the threaded rod.

5. The ladder caddy of claim 1, wherein the aperture is disposed in a center of the handle.

6. The ladder caddy of claim 1, wherein a width of the handle tapers inwardly relative to a longitudinal axis of the handle from a center thereof towards opposing ends of the handle.

7. The ladder caddy of claim 1, wherein the plurality of compartments defined by the plurality of movable walls comprise a circular sector of the base.

8. The ladder caddy of claim 1, wherein a lower end of the threaded rod extends through a lower side of the base, wherein the handle is configured to removably secure to the lower end.

9. A ladder caddy, comprising:
a container having a rectangular base with a perimeter sidewall defining an interior volume with an open upper end;
a threaded rod affixed through a center of the base;
a plurality of movable walls removably securable within the interior volume subdividing the interior volume into a plurality of compartments;
a handle having an aperture therethrough, the handle removably securable to the threaded rod via the aperture.

10. The ladder caddy of claim 9, wherein the plurality of movable walls comprises a length equivalent to at least half of the base, such that the plurality of movable walls secures within the container via frictional engagement.

11. The ladder caddy of claim 9, further comprising at least one slot disposed within the base, wherein the slot is configured to receive a lower edge of a movable wall of the plurality of movable walls therein.

12. The ladder caddy of claim 9, wherein the aperture comprises complementary threading therein configured to removably secure to the threaded rod.

13. The ladder caddy of claim 9, wherein the aperture is disposed in a center of the handle.

14. The ladder caddy of claim 9, wherein a width of the handle tapers inwardly relative to a longitudinal axis of the handle from a center thereof towards opposing ends of the handle.

15. The ladder caddy of claim 9, wherein the plurality of movable walls comprises a variety of lengths.

16. The ladder caddy of claim 15, wherein the plurality of compartments defined by the plurality of movable walls comprise a variety of areas.

17. The ladder caddy of claim 9, wherein a lower end of the threaded rod extends through a lower side of the base, wherein the handle is configured to removably secure to the lower end.
